(19) United States
(12) Patent Application Publication
(10) Pub. No.: US 2021/0124827 A1
(43) Pub. Date: Apr. 29, 2021

(54) METHOD AND SYSTEM FOR CHECKING MALWARE INFECTION OF MACRO INCLUDED IN DOCUMENT FILE

(71) Applicant: SOFTCAMP CO., LTD., Gyeonggi-do (KR)

(72) Inventors: Hwan-Kuk BAE, Gyeonggi-do (KR); Jung-Ho HA, Gyeonggi-do (KR); Jeong-Hyuck KWON, Gyeonggi-do (KR)

(21) Appl. No.: 17/078,908

(22) Filed: Oct. 23, 2020

(30) Foreign Application Priority Data
Oct. 25, 2019 (KR) 10-2019-0133448

(51) Int. Cl. G06F 21/56; G06F 21/52

(52) U.S. Cl. CPC G06F 21/565; G06F 2221/033; G06F 21/52; G06F 21/566

(57) ABSTRACT

A method and system for checking the malware infection of a macro included in a document file, includes: a first checking step of checking, by a macro detection module operating in conjunction with the operating system (OS) of a computer OS, a document file input to an input processor; an extraction step of searching for and extracting, by the macro detection module, a macro function included in the document file based on malware information stored in a code information storage unit; a detection step of detecting, by the macro detection module, malware of the extracted macro function; and a function setting step of changing, by a security processing module, the macro function, from which the malware has been detected, into a custom function.

### CROSS-REFERENCE

This application claims the benefit of Korean Patent Application No. 10-2019-0133448 filed on Oct. 25, 2019, which is hereby incorporated by reference herein in its entirety.

### BACKGROUND

The present invention relates generally to a malware infection checking method and guidance system for performing security processing on a macro of a document infected with malware, and more particularly to a malware infection checking method and guidance system for performing security processing on a macro of a document infected with malware, which detect malware installed in a macro, notify a user of the malware and allow the macro to be selectively executed, thereby enabling a flexible security function to be implemented.

A word processor is software that is used to create, edit, save, and print documents. Representative word processors include Hancom Office released by Hancom Inc., Microsoft Office released by Microsoft, Apache OpenOffice developed by the Apache Foundation, RTF (Rich Text Format) released by Microsoft, PDF (Portable Document Format) released by Adobe, etc.

Meanwhile, a macro is a type of record constructed by grouping several frequently used instructions as a single key input operation, and a word processor sets a program for processing the record.

Accordingly, the inconvenience in which a worker repeatedly uses specific instructions in a specific order during work using a word processor can be minimized using a macro function.

However, macros are frequently used in outside areas for general work purposes, and word processors such as EXCEL® are widely used for work purposes in finance, accounting, and financial sectors. Accordingly, there are frequent cases where hackers install malware in macros and maliciously use them.

In order to overcome this problem, conventionally, there has been proposed a security technology that detects and blocks malware installed in a macro.

However, according to this conventional technology, when malware is detected, the functions of all macros are blocked, so that an operator has to recognize and accept the non-operation status of a macro he or she uses while using a word processor without knowing the reason for blocking. In addition, the function of even a macro without malware is blocked, so that irrationality arises in that an operator has to work in an inefficient work environment.
Prior art document 1: Korean Patent No. 10-1745873 (published on Jun. 27, 2017)

### SUMMARY OF THE INVENTION

The present invention has been conceived to overcome the above-described problems, and an object of the present invention is to provide a malware infection checking method and guidance system for performing security processing on a macro of a document infected with malware, which detect malware installed in a macro, notify a user of the malware and allow the macro to be selectively executed, thereby enabling a flexible security function to be implemented.

According to an aspect of the present invention, there is provided a method of checking the malware infection of a macro included in a document file, the method including: a first checking step of checking, by a macro detection module operating in conjunction with the operating system (OS) of a computer OS, a document file input to an input processor; an extraction step of searching for and extracting, by the macro detection module, a macro function included in the document file based on malware information stored in a code information storage unit; a detection step of detecting, by the macro detection module, malware of the extracted macro function; and a function setting step of changing, by a security processing module, the macro function, from which the malware has been detected, into a custom function.

According to another aspect of the present invention, there is provided a system for checking the malware infection of a macro included in a document file, the system including: a code information storage unit configured to store malware information; a macro detection module configured to extract a macro function of a document file and detect malware by checking a document file input event of an input processor; a security processing module configured to change a macro function, from which malware has been detected, into a custom function and store results of the changing; and a UI module configured to implement a notification presentation function performed during a processing process of the macro detection module.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram showing a malware infection checking system according to an embodiment of the present invention;

FIG. 2 is a flowchart sequentially showing a process of checking a security target document file and changing a corresponding macro function into a custom function in a malware infection checking method according to an embodiment of the present invention;

FIG. 3 is a flowchart sequentially showing a process of executing a security target document file in a malware infection checking method according an embodiment of the present invention;

and

FIG. 4 is an image showing an example of a notification UI presented during processing in the malware infection checking method according to the present invention.

### DETAILED DESCRIPTION OF THE INVENTION

The features and effects of the present invention described above will become apparent through the following detailed description given in conjunction with the accompanying drawings. Accordingly, those of ordinary skill in the art to which the present invention pertains can easily practice the technical spirit of the present invention. The present invention may be modified in various ways and may have various forms. Specific embodiments will be illustrated in the drawings and described in detail in the following description. However, this is not intended to limit the present invention to the specific embodiments, but should be understood as encompassing all changes, equivalents, and substitutes included in the spirit and technical scope of the present invention. The terms used herein are only used to describe the specific embodiments, and are not intended to limit the present invention.

In general, a word processor or document management system is implemented by a combination of hardware and software configurations. Hardware includes a central processing unit (CPU), a memory unit, an input-output unit, a controller, an arithmetic logic unit (ALU), a digital signal processor, a field programmable gate array (FPGA), a programmable logic unit (PLU), etc., and is implemented as one or more general-purpose computers or special-purpose computers. In addition, the processing unit drives an operating system (OS) or one or more applications executed on the OS, and accesses, stores, manipulates, processes, and generates data in response to the execution of software. Such a processing unit may be independently configured, but may include a plurality of processing elements and/or a plurality of types of processing elements. In addition, the software includes an operating system (OS), an input-output control program, and an application program, and allows a processing unit to be operated by a combination of a series of instructions. Software and/or data may be permanently or temporarily embodied via a physical or virtual device, a storage medium, or a transmitted signal wave by a processing unit, or may be distributed over a networked computer system and stored or executed in a distributed manner. Based on such hardware and/or software, a method and system for checking the malware infection of a macro included in a document file according to the present invention can be implemented. Detailed descriptions of known general technologies will be omitted to ensure ease of description and understanding of components and to avoid unnecessary, redundant descriptions.

The present invention will be described in detail below with reference to the accompanying drawings.

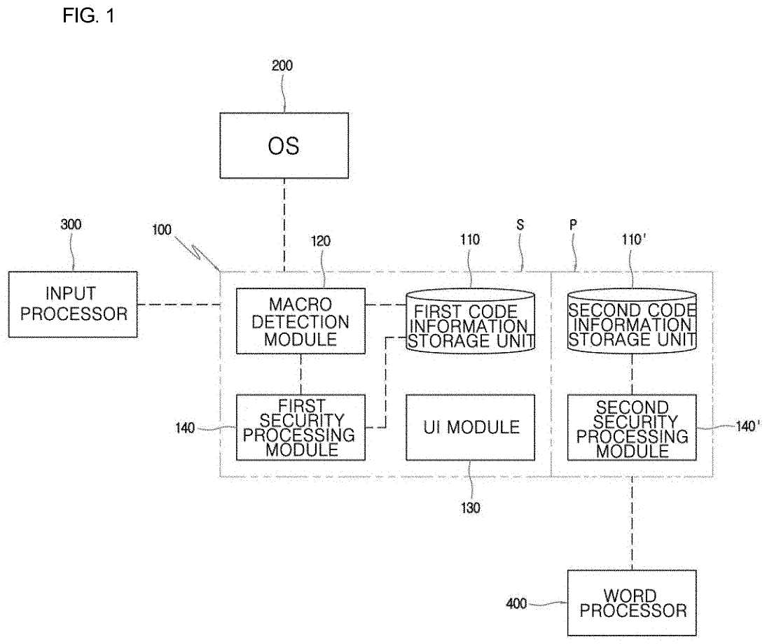

FIG. 1 is a block diagram showing a malware infection checking system 100 according to an embodiment of the present invention.

Referring to FIG. 1, the malware infection checking system 100 according to the present embodiment includes: first and second code information storage units 110 and 110′ configured to store macro function policies and malware information; a macro detection module 120 configured to extract a macro function of a document file and detect malware by checking a document file input event of an input processor 300 based on malware stored in the first code information storage unit 110 of a security part S; a first security processing module 140 configured to change a macro function, from which malware has been detected, into a custom function; a second security processing module 140′ configured to search the macro function policies and the malware information in the second code information storage unit 110′ of the execution part P and to determine whether or not to block the corresponding macro function based on the results of the search; and an UI module 130 configured to implement a notification presentation function performed in the processing processes of the macro detection module 120, the first security processing module 140, and the second security processing module 140′.

In this case, the malware infection checking system 100 according to the present embodiment is divided into the security part S and the execution part S. The security part S and the execution part S perform processing independently of each other. The security part S includes the first code information storage unit 110, the macro detection module 120, the first security processing module 140, and the UI module 130. The execution part P includes the second code information storage unit 110′, the second security processing module 140, and the UI module. Accordingly, the security part S and the execution part P may be constructed in a single terminal computer or server, or may be constructed separately in different terminals (a first embodiment).

However, the present invention is not limited thereto. In the malware infection checking system 100 according to the present invention, the security part S and the execution part P may be integrated with each other without separation. The first and second code information storage units 110 and 110′, the first and second security processing modules 140 and 140′, and the UI modules 130 may constitute the malware infection checking system 100 without separation in an integrated form (a second embodiment).

In the attached claims, each of the first and second code information storage units 110 and 110′, the first and second security processing modules 140 and 140′, and the UI modules 130 is not separated into “first” and “second” units. The security part S and the execution part S are not separated from each other. However, it is clearly noted that the scope of the claims is not limited only to the “second embodiment” but also encompasses the “first embodiment.”

The individual component modules will now be described in greater detail. The first and second code information storage units 110 and 110′ store security policy information set for macro functions and information about malware. In particular, the security policy information includes information including information about whether or not each macro function is an execution blocking target, and a blocking level set for the macro function if the macro function is an execution blocking target.

Furthermore, the malware information stored in the first and second code information storage units 110 and 110′ is continuously updated, and thus the macro detection module 120 may detect new types of malware that are successively generated and developed.

The macro detection module 120 checks an input event for a document file through the input processor 300 while communicating with the operating system (OS) 200 of a computer, and extracts a macro function of the document file, i.e., an input event target. Furthermore, the macro detection module 120 detects the presence of malware in the extracted macro function, and, when malware is detected, sets a security policy for the corresponding macro function, and stores it in the first code information storage unit 110. In this case, the input processor 300 may be various types of hardware and software such as a CD drive, a USB drive, a web browser for online download, and a PtP device. The OS 200 is operated in conjunction with the input processor 300 and transmits an input event for a document file to the macro detection module 120.

When malware is detected in a macro function, the first security processing module 140 of the security unit S classifies the macro function by changing it into a custom function. Thereafter, when the execution unit P attempts to execute the macro function later, the second security processing module 140′ may check whether or not the macro function is a security target, and may determine the security level of the macro function if necessary. When whether or not the macro function is a security target and the security level of the macro function have been determined, whether or not to block the macro function is determined. When the blocking level of the macro function falls within a designated level range, a follow-up process for the blocking of execution is performed according to the selection of an operator.

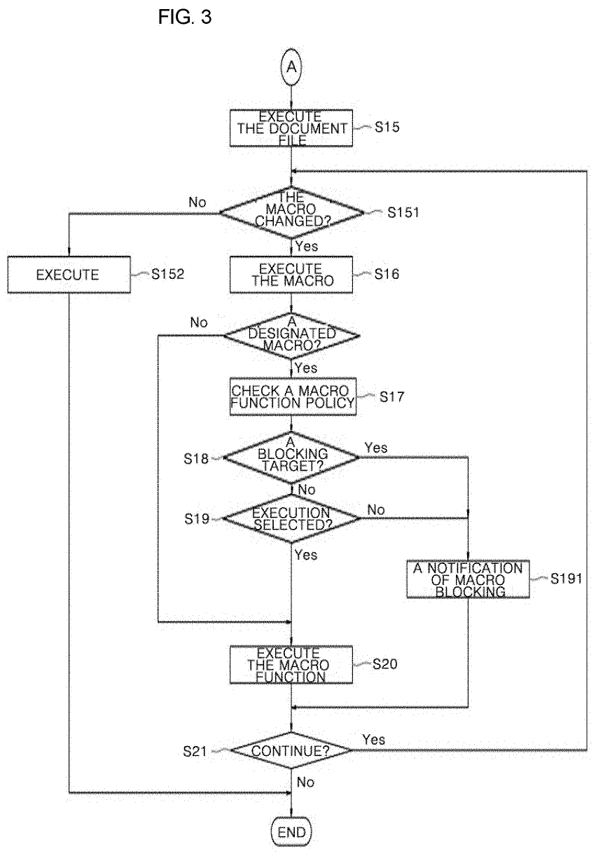

The UI module 130 presents a guide announcement for security against malware while being operated in conjunction with the OS 200 and the word processor 400. In general, a notification window (see FIG. 3) may be displayed for the purpose of providing visual notification. An operator may be notified of the malware infection of a macro function through the issuance of a warning sound and other various methods.

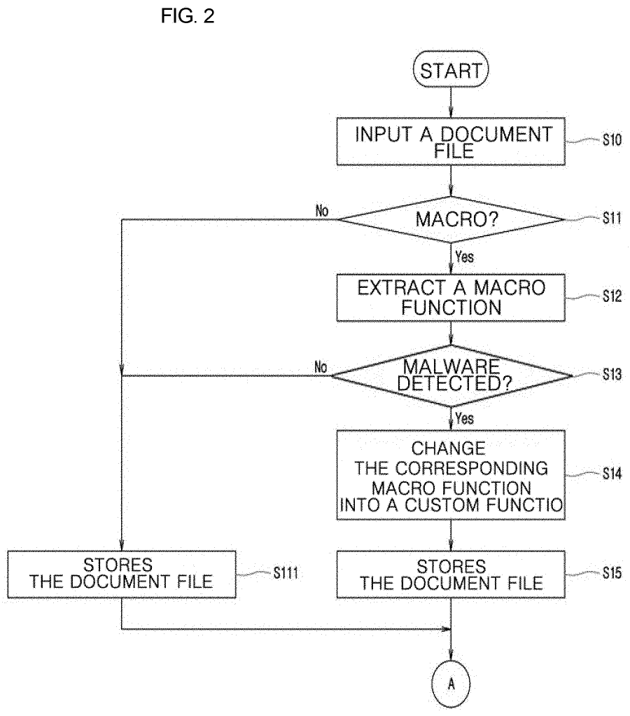

FIG. 2 is a flowchart sequentially showing a process of checking a security target document file and changing a corresponding macro function into a custom function in a malware infection checking method according to an embodiment of the present invention.

The following description will be given with reference to FIGS. 1 and 2.

S10: Document File Reception Step

An operator may create a new document file or input a work target document file from the outside in order to perform work using a document file. In the case where work starts with a new document file without a macro setting, there is no or low possibility of the malware infection of a macro function, and thus a description of the macro security of the new document file will be omitted.

The macro detection module 120 checks for an input event for a document file through the input processor 300 from the OS 200. In the input event for a document file, a document file is detected through the format and extension of an input target file, and the macro detection module 120 performs a follow-up process for the purpose of analyzing the corresponding document file.

S11: Step of Determining Whether or not a Macro is Included

The macro detection module 120 checks the structure of the components of the document file by analyzing the format, extension and header structure of the detected document file, and determines whether or not a macro is included in the corresponding document file through the checking.

When it is determined that the corresponding document file does not include a macro, the document file is set as not a security target and the setting is stored in the corresponding system at step S111. The present document file is not subjected to a process of security processing when the document file is executed later.

S12: Macro Function Extraction Step

The macro detection module 120 extracts a macro function by analyzing the macro of the document file. The code of the macro encoded based on a designated base notation may be expressed in the form of a function by decoding the code of the macro, and based on this, the macro detection module 120 extracts the macro of the document file as a macro function.

S13: Malware Detection Step

The macro detection module 120 determines whether any one of the macro functions mainly used for malicious actions is used in the macro function included in the document file by comparing the extracted macro function with the malware information of the first code information storage unit 110. In greater detail, a macro function infected with malware is deformed into a specific function form. Accordingly, even when normal and malicious macro functions perform the same macro function, they may have different function forms. Therefore, the macro detection module 120 determines whether or not a document file has been infected with a macro function by checking whether or not there is a macro function having the same form as a macro function infected with malware.

For reference, a macro function infected with malware is spread while maintaining a specific form. Accordingly, the first code information storage unit 110 stores the macro function having the corresponding form, and the macro detection module 120 checks whether or not the macro function of the document file has been infected with malware by comparing the malicious macro function stored in the first code information storage unit 110 with the macro function of the document file.

When, as a result of the determination, it is determined that malware is not detected in the macro function of the corresponding document file, the document file is set as not a security target and this setting is stored in the corresponding system at step S111. The present document file is not subjected to a process of security processing when the document file is executed later.

Meanwhile, the macro detection module 120 may classify the malware, detected in the macro function, according to the level of risk. For example, when the malware included in the macro function is primitive malware such as the Stoned virus or the Jerusalem virus, or is classified as malware that does not significantly affect the system, the macro detection module 120 allows an operator to determine whether or not to execute the macro function. In contrast, when the malware included in the macro function is ransomware and other malware having a significant influence on the system, the execution of the macro function is forcibly restricted regardless of the decision of an operator. Through this classification, a document file operator can determine whether or not to execute a macro function according to his or her current situation. Meanwhile, the classification of the macro detection module 120 may be performed when the document file is executed.

S14: Step of Changing into a Custom Function

Meanwhile, when malware is detected in the macro function of the document file, the first security processing module 140 of the security unit S sets the document file as a security target and changes the macro function of the document file into a custom function. The macro function changed into the custom function is recognized by the second security processing module 140′ when the document file and the macro function are executed in the execution unit P, and whether or not to execute them and the like may be directly controlled.

As described above, the document file having the macro function processed according to the above-described process is stored and managed in the corresponding system.

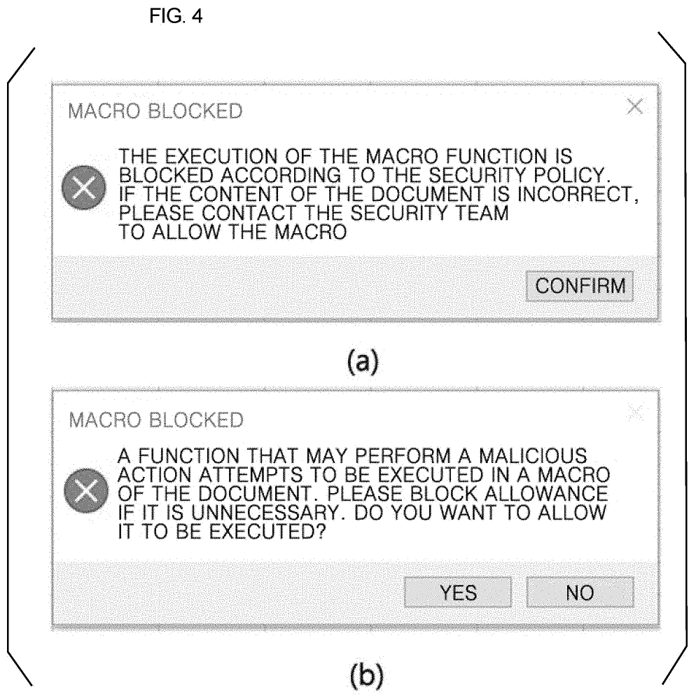

FIG. 3 is a flowchart sequentially showing a process of executing a security target document file in a malware infection checking method according to an embodiment of the present invention. FIG. 4 is an image showing an example of a notification UI presented during processing in the malware infection checking method according to the present invention.

The following description will be given with reference to FIGS. 1 to 4.

S15: Document File Execution Step

In the execution part P, an operator searches for and executes a document file, stored and managed in the system, via the word processor 400.

As described above, since a document file having a macro function set as a security target is stored with the macro function changed into a custom function, the operator may load the required document file via the related word processor 400 later.

S151: Macro Checking Step

The second security processing module 140′ determines whether or not the macro of the retrieved document file has been changed, and the word processor 400 executes the corresponding document file without a follow-up process when it is determined that the macro has not been changed at step S152.

S16: Designated Macro Detection Step

When it is determined that the macro of the retrieved document file has been changed, the second security processing module 140′ detects an execution event for a macro function while checking the processing of the word processor 400 in real time. When, as a result of the checking, an execution event for a macro function occurs, the event is interrupted and it is checked whether or not the corresponding macro function has been changed into a custom function.

When, as a result of the checking, the macro function is a general macro function other than a custom function, the second security processing module 140′ continues the execution thereof. In contrast, when the macro function is a custom function, the macro function is considered to be malicious and then a follow-up process is performed.

S17: Macro Function Policy Checking Step

The second security processing module 140′ analyzes the macro function changed into a custom function because the macro function is determined to be malicious, and searches the second code information storage unit 110′ or its own security policies.

As an example, in greater detail, although the second security processing module 140′ recognized that the macro function to be executed by the word processor 400 was malicious and changed it into a custom function, it may be determined as a result of checking in the second code information storage unit 110′ that it is not an execution restriction target. In this case, the second security processing module 140′ determines that the macro function to be executed is normal and continues the execution of the macro function. However, when, as a result of checking in the second code information storage unit 110′, it is determined that the macro function is an execution restriction target, the execution target macro function is determined to be dangerous, and the execution restriction of the macro function is continued.

In addition, the security policies are set such that the risk levels of malicious macro functions are graded, and thus the second security processing module 140′ may determine the risk level of the macro function changed into the custom function according to the security policies. In the present embodiment, the risk level of the macro function is classified into a level at which execution is forcibly blocked, a level at which execution is selectively blocked by an operator, and a level at which execution is normally performed. Accordingly, the second security processing module 140′ searches for and determines the risk level of the macro function to be executed according to the security policies.

Although the above-described process of grading and classifying the risk of a malicious macro function infected with malware may be performed by the second security processing module 140′ at this step S17, it may be performed by the macro detection module 120 of the security unit S at the malware detection step S13, as described above.

S18: Blocking Target Detection Step

When, as a result of the checking by the second security processing module 140′, the risk level of the macro function to be executed is determined to be a level at which execution is forcibly blocked, the second security processing module 140′ forcibly blocks the execution of the corresponding macro function, and the UI module (not shown) of the execution part P pops up a notification window as shown in FIG. 4(a) and notifies an operator of forced blocking and a reason for the blocking at step S191.

S19: Execution Selecting Step

When, as a result of the checking by the second security processing module 140′, it is determined that the risk level of the macro function to be executed is a level at which execution is selectively blocked, the second security processing module 140′ stops the execution of the corresponding macro function, and the UI module pops up a notification window as shown in FIG. 4(b) and inquires of an operator about whether or not to execute the corresponding macro function.

When, as a result of the query, the operator selects to block execution, the second security processing module 140′ stops the execution of the corresponding macro function, and the UI module pops up a notification window as shown in FIG. 4(a) and notifies an operator of the forced blocking and a reason for the blocking at step S191.

S20: Macro Function Execution Step

When, as a result of the above query, the operator selects to allow execution, the second security processing module 140′ releases the stopping of the execution of the macro function, and the word processor 400 executes the corresponding macro function.

Thereafter, when the execution of the macro function is subsequently attempted in the continuous word processing process at S21, the second security processing module 140′ repeats the macro execution step S16.

The present invention is advantageous in that the present invention detects malware installed in a macro, notifies a user of the malware and allows the macro to be selectively executed, thereby enabling a flexible security function to be implemented, in that when a blocked macro is executed, the present invention notifies a user of execution being blocked, thereby ensuring the continuity of the processing of work, and in that normal work files including macros are allowed, thereby providing a safe, convenient work environment.

While the above-described detailed description of the present invention has been given with reference to the preferred embodiments of the present invention, it will be understood by those skilled in the art or those having ordinary knowledge in the art that the present invention may be modified and altered in various manners without departing from the technical scope and spirit of the present invention that are described in the attached claims.

What is claimed is:

1. A method of checking malware infection of a macro included in a document file, the method comprising:
a first checking step of checking, by a macro detection module operating in conjunction with an operating system (OS) of a computer OS, a document file input to an input processor;
an extraction step of searching for and extracting, by the macro detection module, a macro function included in the document file based on malware information stored in a code information storage unit;
a detection step of detecting, by the macro detection module, malware of the extracted macro function; and
a function setting step of changing, by a security processing module, the macro function, from which the malware has been detected, into a custom function.

2. The method of claim 1, further comprising:
a second checking step of, after the document file has been executed by a word processor, interrupting, by the security processing module, an execution event for a macro, and checking, by the security processing module, a policy for the corresponding macro function; and
a macro function blocking step of, when as a result of the policy checking, the macro function is an execution blocking target, stopping, by the security processing module, execution of the macro function, and presenting, by the security processing module, a notification via a UI module.

3. The method of claim 1, wherein:
The policy for the macro function is graded according to a risk level of the malware; and
the detection step includes setting, by the macro detection module, the risk level for the malware, or the second checking step includes setting, by the security processing module, the risk level for the malware.

4. The method of claim 2, wherein the second checking step includes, when the macro function has a designated level, outputting, by the security processing module, a query window via the UI module, collecting, by the security processing module, a selection value of an operator, and allowing, by the security processing module, the blocking step or execution of the macro function to follow depending on the selection value.

5. The method of claim 1, further comprising, before the second checking step, interrupting, by the security processing module, an execution event for the macro after execution of the document file, checking, by the security processing module, whether the corresponding macro function has been changed into a custom function, and allowing, by the security processing module, the execution of the corresponding macro function to continue when, as a result of the checking, it is determined that the corresponding macro function has not been changed into a custom function.

6. A system for checking malware infection of a macro included in a document file, the system comprising:
a code information storage unit configured to store malware information;
a macro detection module configured to extract a macro function of a document file and detect malware by checking a document file input event of an input processor;
a security processing module configured to change a macro function, from which malware has been detected, into a custom function and store results of the changing; and
a UI module configured to implement a notification presentation function performed during a processing process of the macro detection module.

7. The system of claim 6, wherein:
the code information storage unit stores macro function policies;
the security processing module searches the macro function policies and the malware information in the code information storage unit, and determines whether or not to block a corresponding macro function based on results of the searching; and
the UI module implements a notification presentation function performed in a processing process of the security processing module.
